(19) United States
(12) Patent Application Publication
(10) Pub. No.: US 2026/0346606 A1
(43) Pub. Date: Nov. 5, 2026

(54) LIQUID DROPLET DISCHARGE HEAD AND RECORDING DEVICE

(71) Applicant: KYOCERA Corporation, Kyoto (JP)

(72) Inventors: Yuusuke TSUTSUMI, Yanagawa-shi, Fukuoka (JP); Keisuke MAKISE, Kirishima-shi, Kagoshima (JP)

(21) Appl. No.: 19/488,589

(22) PCT Filed: May 29, 2024
(86) PCT No.: PCT/JP2024/019787

§ 371 Date: Nov. 27, 2025

(30) Foreign Application Priority Data
May 29, 2023 (JP) 2023-088037

(51) Int. Cl. B41J 2/14

(52) U.S. Cl. CPC B41J 2/1433; B41J 2/14233; B41J 2202/03; B41J 2202/11

(57) ABSTRACT

A liquid droplet discharge head includes a channel member, a base film, and a water-repellent film. The channel member includes a plurality of discharge holes in a first surface. The base film is located on the first surface. The water-repellent film is located on the base film. The base film located in an edge region including an edge of the discharge hole has a film thickness that decreases toward the edge.

### CROSS-REFERENCE TO RELATED APPLICATIONS

This application is national stage application of International Application No. JP2024/019787, filed on May 29, 2024, which designates the United States, and which claims the benefit of priority from Japanese Patent Application No. 2023-088037, filed on May 29, 2023.

### TECHNICAL FIELD

The present disclosure relates to a liquid droplet discharge head and a recording device.

### BACKGROUND OF INVENTION

A known printing device is an inkjet printer or an inkjet plotter using an inkjet recording method. A liquid droplet discharge head for discharging liquid is installed in such a printing device utilizing an inkjet method.

### CITATION LIST

### Patent Literature

Patent Document 1: JP H06-246921 A

### SUMMARY

An aspect of the present disclosure provides a liquid droplet discharge head including a channel member, a base film, and a water-repellent film. The channel member includes a plurality of discharge holes in a first surface. The base film is located on the first surface. The water-repellent film is located on the base film. The base film located in an edge region including an edge of the discharge hole has a film thickness that decreases toward the edge.

### BRIEF DESCRIPTION OF THE DRAWINGS

FIG. 1 is a schematic side view of a printer according to an embodiment.

FIG. 2 is a schematic plan view of the printer according to the embodiment.

FIG. 3 is a schematic exploded perspective view of a liquid droplet discharge head according to the embodiment.

FIG. 4 is an enlarged plan view of a head body according to embodiment.

FIG. 5 is an enlarged view of a region surrounded by a dot-dashed line illustrated in FIG. 4.

FIG. 6 is a cross-sectional view taken along line VI-VI illustrated in FIG. 4.

FIG. 7 is a cross-sectional view taken along line VII-VII illustrated in FIG. 5.

FIG. 8 is a plan view of a base film illustrated in FIG. 7.

### DESCRIPTION OF EMBODIMENTS

In the following, embodiments for implementing a liquid droplet discharge head and a recording device according to the present disclosure (hereinafter referred to as “embodiments”) will be described with reference to the accompanying drawings. Note that the present disclosure is not limited by the embodiments. The embodiments can also be combined as appropriate as long as no inconsistencies arise in the process. In the following embodiments, the same parts are denoted by the same reference signs, and redundant descriptions are omitted.

In the following embodiments, expressions such as “certain”, “orthogonal”, “perpendicular”, and “parallel” may be used, but these expressions need not mean exactly “certain”, “orthogonal”, “perpendicular”, and “parallel”. In other words, each of the expressions described above allows for deviations in, for example, manufacturing accuracy, or installation accuracy.

In the drawings referenced below, to facilitate understanding, an orthogonal coordinate system may be defined, in which the X-axis direction, Y-axis direction, and Z-axis direction are mutually orthogonal, and the positive Z-axis direction is set as the vertically upward direction. In some cases, the rotational direction about the vertical axis may be referred to as the θ direction.

Patent Document 1 discloses a technique of forming a water-repellent surface on a surface of a nozzle plate on which nozzles are located, the water-repellent surface not causing flying deflection of ink droplets. A liquid droplet discharge head is known which has a base film between the water-repellent surface and the nozzle plate, in order to increase the adhesion between the water-repellent surface and the nozzle plate. The water-repellent surface and the base film are formed by forming a base film on the surface of the nozzle plate, forming a water-repellent film thereon, and performing a heating treatment or a drying treatment as necessary.

However, if the base film is formed inside the edge of the nozzle in the process of manufacturing the water-repellent surface and the base film, the water-repellent surface thereon is also formed inside the edge of the nozzle, and as a result, the nozzle tip has water repellency, and the discharge may become unstable.

A technique for improving discharge stability is anticipated.

### Configuration of Printer

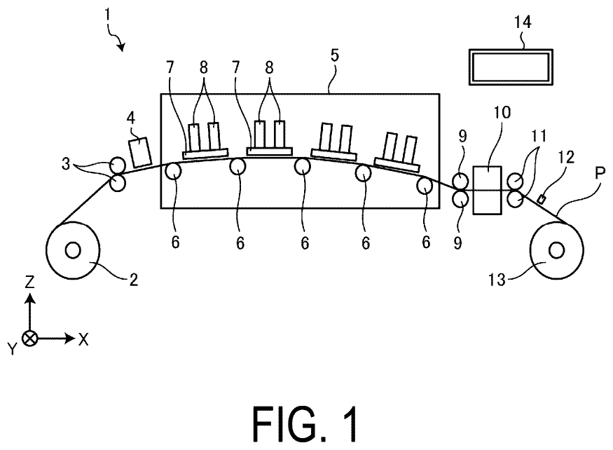

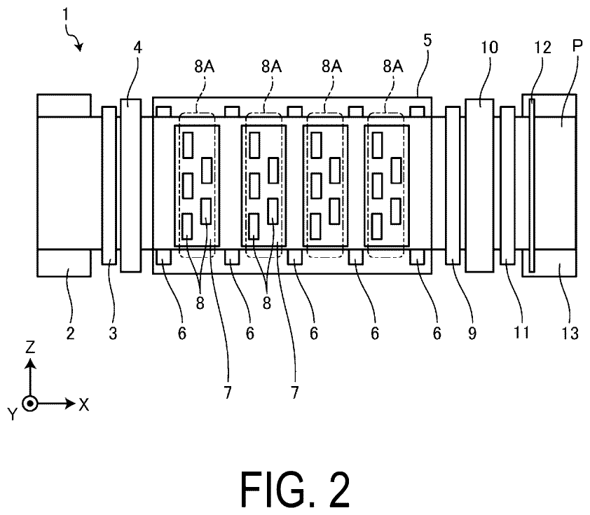

First, an outline of a printer 1, which is an example of a recording device according to an embodiment, will be described with reference to FIGS. 1 and 2. FIG. 1 is a schematic side view of the printer 1 according to the embodiment, and FIG. 2 is a schematic plan view of the printer 1 according to the embodiment. The printer 1 according to an embodiment is, for example, a color inkjet printer.

As illustrated in FIG. 1, the printer 1 includes a paper feed roller 2, a pair of guide rollers 3, an applicator 4, a head case 5, a plurality of transport rollers 6, a plurality of frames 7, a plurality of liquid droplet discharge heads 8, a pair of transport rollers 9, a dryer 10, a pair of transport rollers 11, a sensor unit 12, and a collection roller 13.

The printer 1 further includes a controller 14 that controls the paper feed roller 2, the pair of guide rollers 3, the applicator 4, the head case 5, the plurality of transport rollers 6, the plurality of frames 7, the plurality of liquid droplet discharge heads 8, the pair of transport rollers 9, the dryer 10, the pair of transport rollers 11, the sensor unit 12, and the collection roller 13.

The printer 1 records images or characters on a printing paper P by causing liquid droplets to land on the printing paper P. The printing paper P is an example of a recording medium. The printing paper P is wound around the paper feed roller 2 before use. The printer 1 transports the printing paper P from the paper feed roller 2 to the inside of the head case 5 through the pair of guide rollers 3 and the applicator 4.

The applicator 4 uniformly applies a coating agent to the printing paper P. This can apply surface treatment to the printing paper P, so that the printing quality of the printer 1 can be improved.

The head case 5 accommodates the plurality of transport rollers 6, the plurality of frames 7, and the plurality of liquid droplet discharge heads 8. The inside of the head case 5 forms a space isolated from the outside except for a portion connected to the outside such as a portion where the printing paper P enters and leaves.

In the internal space of the head case 5, at least one of the controlling factors such as temperature, humidity, and air pressure is controlled by the controller 14 as required. The transport rollers 6 transport the printing paper P to the vicinity of the liquid droplet discharge heads 8 inside the head case 5.

The frame 7 is a rectangular flat plate and positioned above and in proximity to the printing paper P transported by the transport rollers 6. As illustrated in FIG. 2, the frame 7 is positioned such that the longitudinal direction thereof is orthogonal to a transport direction of the printing paper P. The plurality (e.g., four) of frames 7 are positioned inside the head case 5 along the transport direction of the printing paper P.

A liquid, for example, ink, is supplied from a liquid tank (not illustrated) to the liquid droplet discharge head 8. The liquid droplet discharge head 8 discharges liquid droplets supplied from the liquid tank.

The controller 14 controls the liquid droplet discharge heads 8 based on data such as images or characters to discharge the liquid droplets toward the printing paper P. The distance between the liquid droplet discharge head 8 and the printing paper P is, for example, about 0.5 to 20 mm.

The liquid droplet discharge head 8 is fixed to the frame 7. The liquid droplet discharge head 8 has both ends in the longitudinal direction, which are, for example, fixed to the frame 7. The liquid droplet discharge head 8 is positioned such that the longitudinal direction thereof is orthogonal to the transport direction of the printing paper P.

That is, the printer 1 according to the embodiment is a so-called line printer in which the liquid droplet discharge heads 8 are fixed inside the printer 1. The printer 1 according to the embodiments is not limited to a line printer, but may be a so-called serial printer. The serial printer is a printer that alternately performs the operation of recording and the transport of the printing paper P. This operation of recording is performed while moving the liquid droplet discharge head 8 in a direction crossing the transport direction of the printing paper P, for example, by reciprocating in a direction substantially orthogonal to the transport direction.

As illustrated in FIG. 2, a plurality of (e.g., five) the liquid droplet discharge heads 8 are fixed in one frame 7. FIG. 2 illustrates an example in which three of the liquid droplet discharge heads 8 are positioned on the front side and two of them are positioned on the rear side in the transport direction of the printing paper P. The liquid droplet discharge heads 8 are positioned such that the centers thereof do not overlap each other in the transport direction of the printing paper P.

The plurality of liquid droplet discharge heads 8 positioned in one frame 7 constitute a head group 8A. Four of the head groups 8A are positioned along the transport direction of the printing paper P. The same color ink is supplied to the liquid droplet discharge heads 8 belonging to the same head group 8A. Thus, the printer 1 can perform printing with four colors of ink by using the four head groups 8A.

The colors of the ink discharged from the respective head groups 8A are, for example, magenta (M), yellow (Y), cyan (C), and black (K). The controller 14 can print a color image on the printing paper P by controlling each of the head groups 8A and discharging inks of a plurality of colors onto the printing paper P.

Note that, in order to treat the surface of the printing paper P, the liquid droplet discharge heads 8 may discharge the coating agent onto the printing paper P.

The number of the liquid droplet discharge heads 8 included in one of the head groups 8A or the number of the head groups 8A mounted on the printer 1 can be changed as appropriate in accordance with a printing object or printing conditions. For example, when the color to be printed on the printing paper P is a single color and the printing range can be covered by one liquid droplet discharge head 8, the number of liquid droplet discharge heads 8 mounted on the printer 1 may be one.

The printing paper P that has been printed inside the head case 5 is transported to the outside of the head case 5 by the pair of transport rollers 9, and passes through the inside of the dryer 10. The dryer 10 dries the printing paper P that has been printed. The printing paper P that has been dried by the dryer 10 is transported by the pair of transport rollers 11 and collected by the collection roller 13.

In the printer 1, drying the printing paper P with the dryer 10 can reduce adhesion of the printing paper P wound in an overlapping manner, and rubbing of undried liquid at the collection roller 13.

The sensor unit 12 is constituted by, for example, a position sensor, a speed sensor, or a temperature sensor. Based on information from the sensor unit 12, the controller 14 can determine the state of each unit of the printer 1 and control each unit of the printer 1.

The printer 1 described above uses the printing paper P as the printing object (i.e., the recording medium), but the printing object in the printer 1 is not limited to the printing paper P. For example, the printing object may be rolled cloth.

Instead of directly transporting the printing paper P itself, the printer 1 may transport the object placed on a transport belt. By using the transport belt, the printer 1 can use a sheet of paper, a cut cloth, wood, a tile, or the like as the printing object.

The printer 1 may print wiring patterns of an electronic device by discharging liquid droplets containing conductive particles from the liquid droplet discharge heads 8. The printer 1 may also discharge a predetermined amount of a liquid chemical agent or liquid droplets containing the chemical agent from the liquid droplet discharge heads 8 onto a reaction vessel or the like to produce chemicals.

### Configuration of Liquid Droplet Discharge Head

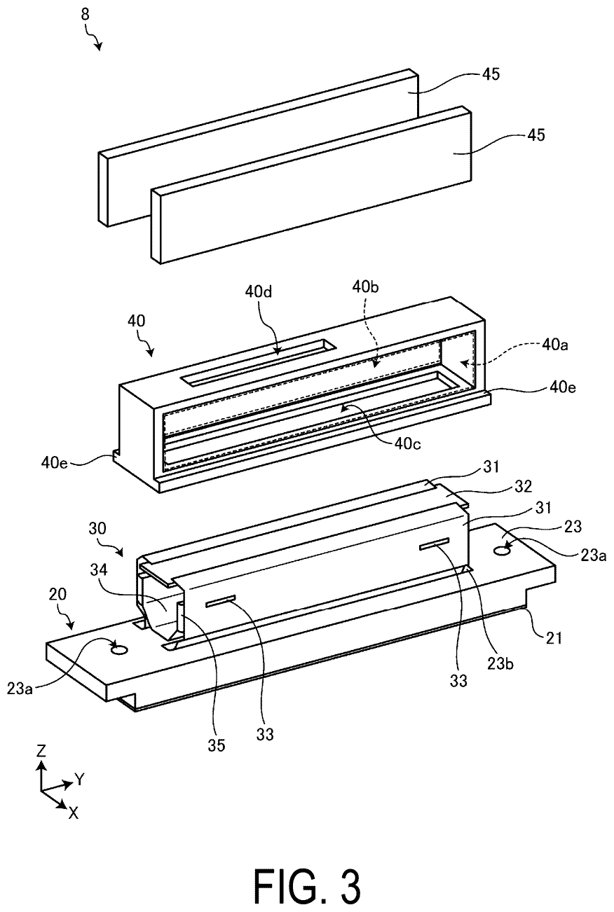

The configuration of the liquid droplet discharge head 8 according to the embodiment will be described below with reference to FIG. 3. FIG. 3 is a schematic exploded perspective view of the liquid droplet discharge head 8 according to the embodiment.

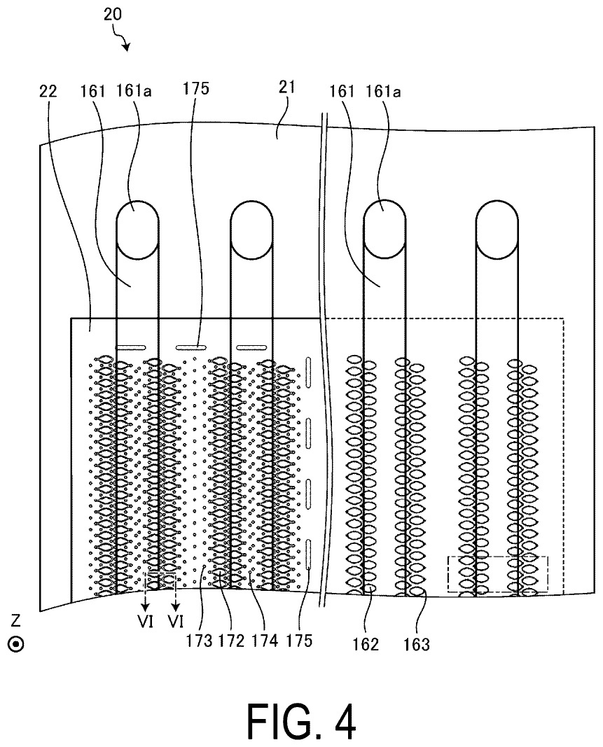

The liquid droplet discharge head 8 includes a head body 20, a wiring portion 30, a casing 40, and a pair of heat dissipation plates 45. The head body 20 includes a channel member 21, a piezoelectric actuator 22 (see FIG. 4), and a reservoir 23.

In the following description, for convenience, a direction in which the head body 20 is provided in the liquid droplet discharge head 8 may be represented as “lower”, and a direction in which the casing 40 is provided with respect to the head body 20 may be represented as “upper”.

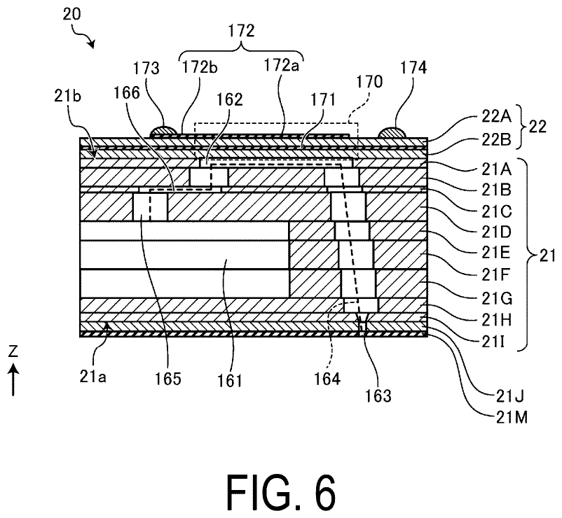

The channel member 21 of the head body 20 has a substantially flat plate shape, and includes a first surface 21a, which is one main surface, and a second surface 21b (see FIG. 6) located on the opposite side of the first surface 21a.

A plurality of discharge holes 163 (see FIG. 6) for discharging the liquid droplet to the printing paper P are located in the first surface 21a. The second surface 21b includes an opening (not illustrated), and a liquid is supplied from the reservoir 23 to the inside of the channel member 21 through the opening. The channel member 21 has therein a channel, through which liquid flows from the second surface 21b to the first surface 21a.

The piezoelectric actuator 22 is located on the first surface 21a of the channel member 21. The piezoelectric actuator 22 includes a plurality of displacement elements 170 (see FIG. 6). The flexible substrate 31 of the wiring portion 30 is electrically connected to the piezoelectric actuator 22.

The reservoir 23 is located on the piezoelectric actuator 22. The reservoir 23 is provided with openings 23a at both ends in the main scanning direction, which is orthogonal to the transport direction of the printing paper P and parallel to the printing paper P. The reservoir 23 internally includes a channel, and the liquid is supplied to the reservoir 23 from the outside through the openings 23a. The reservoir 23 supplies liquid to the channel member 21. The reservoir 23 also stores liquid supplied to the channel member 21.

The wiring portion 30 includes the flexible substrate 31, a wiring board 32, a plurality of driver ICs 33, a pressing member 34, and an elastic member 35. The flexible substrate 31 transmits, to the head body 20, a predetermined signal transmitted from the outside. As illustrated in FIG. 3, the liquid droplet discharge head 8 according to the embodiment may include two flexible substrates 31.

One end of the flexible substrate 31 is electrically connected to the piezoelectric actuator 22 of the head body 20. The other end of the flexible substrate 31 is drawn upward so as to pass through a slit 23b of the reservoir 23, and is electrically connected to the wiring board 32. Thus, the piezoelectric actuator 22 of the head body 20 can be electrically connected to the outside.

The wiring board 32 is positioned above the head body 20. The wiring board 32 distributes signals to a plurality of driver ICs 33.

The plurality of driver ICs 33 are positioned on one main surface of the flexible substrate 31. As illustrated in FIG. 3, in the liquid droplet discharge head 8 according to the embodiment, two driver ICs 33 are provided on one flexible substrate 31, but the number of the driver ICs 33 provided on one flexible substrate 31 is not limited to two.

The driver IC 33 drives the piezoelectric actuator 22 of the head body 20 based on the driving signal sent from the controller 14 (see FIG. 1). This causes the driver IC 33 to drive the liquid droplet discharge head 8.

The pressing member 34 is substantially U-shaped in cross-sectional view, and presses the driver ICs 33 on the flexible substrate 31 toward the heat dissipation plate 45 from the inside. With this configuration, the embodiment enables heat generated when the driver IC 33 drives to be efficiently dissipated to the heat dissipation plate 45 on the outer side.

The elastic member 35 is provided so as to come into contact with the outer wall of the pressing member (not illustrated) of the pressing member 34. By providing such the elastic member 35, the possibility can be reduced that the pressing member 34 damages the flexible substrate 31 when the pressing member 34 presses the driver ICs 33.

The elastic member 35 is made of, for example, a foam double-sided tape. The heat dissipation of the driver IC 33 can be improved by using, for example, a non-silicon heat conductive sheet as the elastic member 35. Note that it is not necessary to provide the elastic member 35.

The casing 40 is positioned on the head body 20 so as to cover the wiring portion 30. Thus, the casing 40 can seal the wiring portion 30. The casing 40 is made of, for example, resin or metal.

The casing 40 has a box shape extending long in the main scanning direction, and has a first opening 40a and a second opening 40b on a pair of side surfaces facing each other along the main scanning direction. The casing 40 has a third opening 40c on the lower surface and a fourth opening 40d on the upper surface.

In the first opening 40a, one of the heat dissipation plates 45 is positioned to close the first opening 40a, and in the second opening 40b, the other of the heat dissipation plates 45 is positioned to close the second opening 40b.

Each of the heat dissipation plates 45 is provided to extend in the main scanning direction, and is made of a metal, alloy or the like, having high heat dissipation property. Each of the heat dissipation plates 45 is provided in contact with the corresponding driver ICs 33 to dissipate heat generated in those driver ICs 33.

The pair of heat dissipation plates 45 are each fixed to the casing 40 by screws (not illustrated). Thus, the casing 40, to which the heat dissipation plates 45 are fixed, has a box shape in which the first opening 40a and the second opening 40b are closed, and the third opening 40c and the fourth opening 40d are opened.

The third opening 40c is positioned so as to face the reservoir 23. The flexible substrates 31 and the pressing member 34 are inserted into the third opening 40c.

The fourth opening 40d is provided to allow a connector (not illustrated) provided on the wiring board 32 to be inserted therein. When the space between the connector and the fourth opening 40d is sealed with resin or the like, liquid or dust is less likely to enter the casing 40.

The casing 40 includes an insulation portion 40e. The insulation portion 40e is disposed adjacent to the first opening 40a and the second opening 40b, and protrudes outward from the side surface of the casing 40 along the main scanning direction.

The insulation portion 40e is formed so as to extend in the main scanning direction. That is, the insulation portion 40e is positioned between the heat dissipation plate 45 and the head body 20. Thus, by providing the insulation portion 40e in the casing 40, the heat generated in the driver ICs 33 is less likely to be transmitted to the head body 20 through the heat dissipation plate 45.

FIG. 3 illustrates an example of the configuration of the liquid droplet discharge head 8, and may further include members other than those illustrated in FIG. 3.

### Configuration of Head Body

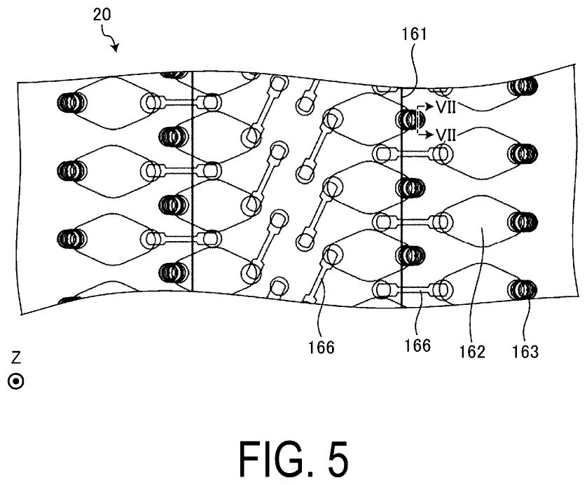

The configuration of the head body 20 according to the embodiment will be described with reference to FIGS. 4 to 6. FIG. 4 is an enlarged plan view of the head body 20 according to the embodiment. FIG. 5 is an enlarged view of a region surrounded by a dot-dashed line illustrated in FIG. 4. FIG. 6 is a cross-sectional view taken along line VI-VI illustrated in FIG. 4. In FIG. 4, the right side region is illustrated as a transparent region.

As illustrated in FIG. 4, the head body 20 includes the channel member 21 and the piezoelectric actuator 22. The channel member 21 includes a supply manifold 161, a plurality of pressurizing chambers 162, and a plurality of discharge holes 163.

The plurality of pressurizing chambers 162 are connected to the supply manifold 161. The plurality of discharge holes 163 are respectively connected to the plurality of pressurizing chambers 162.

The pressurizing chamber 162 is opened to the second surface 21b of the channel member 21 (see FIG. 6). The second surface 21b of the channel member 21 has the opening 161a connected to the supply manifold 161. Liquid is supplied from the reservoir 23 (see FIG. 3) to the inside of the channel member 21 via the openings 23a.

In the example illustrated in FIG. 4, the head body 20 includes four supply manifolds 161 inside the channel member 21. The supply manifold 161 has a long thin shape extending along the longitudinal direction of the channel member 21, and at each of both ends, the opening 161a of the supply manifold 161 is formed in the second surface 21b of the channel member 21.

In the channel member 21, a plurality of pressurizing chambers 162 are formed extending two-dimensionally. A pressurizing chamber 162 is a hollow region having a substantially diamond-shaped planar shape with rounded corners. The pressurizing chamber 162 opens in the second surface 21b of the channel member 21, and is closed by joining the piezoelectric actuator 22 to the second surface 21b.

The pressurizing chambers 162 constitute pressurizing chamber row arranged longitudinally. The pressurizing chambers 162 of each pressurizing chamber row is arranged staggered between two adjacent pressurizing chamber rows. Two pressurizing chamber rows connected to one supply manifold 161 constitute one pressurizing chamber group. In the example illustrated in FIG. 4, the channel member 21 includes four pressurizing chamber groups.

The relative arrangement of the pressurizing chambers 162 within each pressurizing chamber group is the same, and each pressurizing chamber group is slightly shifted in the longitudinal direction from each other.

The discharge hole 163 is disposed so as to avoid the region facing the supply manifold 161 in the channel member 21. That is, when the channel member 21 is viewed through the second surface 21b, the discharge hole 163 does not overlap the supply manifold 161.

When viewed in plan view, the discharge holes 163 are positioned so as to fit in the mounting region of the piezoelectric actuator 22. As a group, such discharge holes 163 occupy a region of substantially the same size and shape as the piezoelectric actuator 22.

Liquid droplets are discharged from the discharge hole 163 by displacing the displacement element 170 (see FIG. 6), which is the corresponding pressurizing portion of the piezoelectric actuator 22.

As illustrated in FIG. 6, the channel member 21 has a laminated structure in which a plurality of plates are laminated. As these plates, a cavity plate 21A, a base plate 21B, an aperture (throttle) plate 21C, a supply plate 21D, manifold plates 21E, 21F, and 21G, a cover plate 21H, and a nozzle plate 21I are provided in this order from the second surface 21b side of the channel member 21. The plates constituting the channel member 21 are made of metal such as stainless steel.

The plates constituting the channel member 21 have many holes. The thickness of each plate is about 10 μm to 300 μm. This can increase the accuracy of hole formation. The plates are laminated in alignment so that these holes communicate with each other to constitute an individual channel 164 and a supply manifold 161.

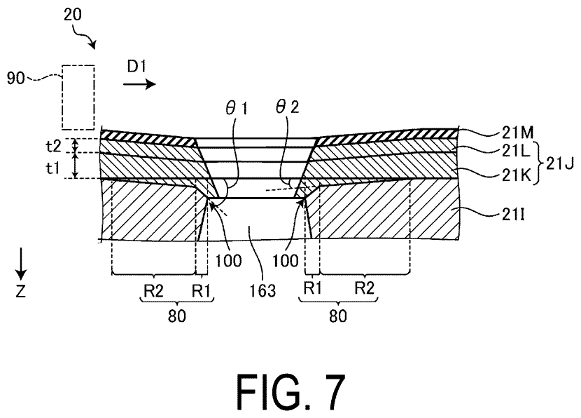

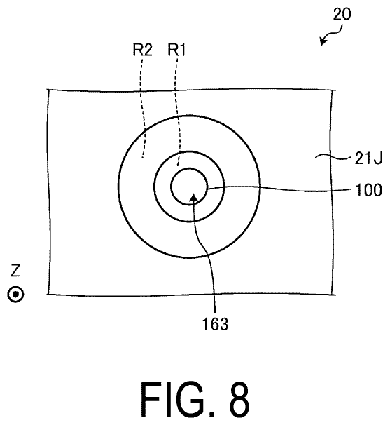

The head body 20 includes a base film 21J located on the first surface 21a of the channel member 21 and a water-repellent film 21M located on the base film 21J. The base film 21J and the water-repellent film 21M will be described later with reference to FIGS. 7 and 8.

In the channel member 21, the supply manifold 161 and the discharge hole 163 are connected by the individual channel 164. The supply manifold 161 is positioned on the first surface 21a side inside the channel member 21, and the discharge hole 163 is positioned at the first surface 21a of the channel member 21.

The individual channel 164 includes the pressurizing chamber 162 and an individual supply channel 165. The pressurizing chamber 162 is located on the second surface 21b of the channel member 21, and the individual supply channel 165 is a channel connecting the supply manifold 161 and the pressurizing chamber 162.

The individual supply channel 165 includes a throttle 166 which is narrower than other parts. The throttle 166 is narrower in width than other parts of the individual supply channel 165, so that the channel resistance is high. Thus, when the channel resistance of the throttle 166 is high, the pressure generated in the pressurizing chamber 162 is difficult to escape to the supply manifold 161.

The piezoelectric actuator 22 includes piezoelectric ceramic layers 22A, 22B, a common electrode 171, an individual electrode 172, a connecting electrode 173, a dummy connecting electrode 174, and a surface electrode 175 (see FIG. 4).

The piezoelectric actuator 22 includes the piezoelectric ceramic layer 22B, the common electrode 171, the piezoelectric ceramic layer 22A, and the individual electrode 172 layered in this order.

Each of the piezoelectric ceramic layers 22A and 22B has a thickness of about 20 μm. Each layer of the piezoelectric ceramic layers 22A and 22B extends over a plurality of pressurizing chambers 162. The piezoelectric ceramic layers 22A and 22B can be used, which is composed of a ferroelectric lead zirconate titanate (PZT)-based ceramic material.

The common electrode 171 is formed in the region between the piezoelectric ceramic layer 22A and the piezoelectric ceramic layer 22B over the substantially entire surface in the plane direction. That is, the common electrode 171 overlaps all the pressurizing chambers 162 in the region facing the piezoelectric actuator 22. The thickness of the common electrode 171 is about 2 μm. For the common electrode 171, a metal material such as an Ag—Pd-based metal material can be used.

The individual electrode 172 includes an individual electrode body 172a and an extraction electrode 172b. The individual electrode body 172a is located on the piezoelectric ceramic layer 22B, in the region facing the pressurizing chamber 162. The individual electrode body 172a is one size smaller than the pressurizing chamber 162 and has a shape substantially similar to that of the pressurizing chamber 162.

The extraction electrode 172b extends from the individual electrode body 172a. The connecting electrode 173 is located at one end of the extraction electrode 172b, which extends out of the region facing the pressurizing chamber 162. The individual electrode 172 can be used, which is composed of a metal material such as Au base.

The connecting electrode 173 is located on the extraction electrode 172b and has a thickness of about 15 μm and is convex. The connecting electrode 173 is electrically joined to an electrode provided on the flexible substrate 31 (see FIG. 3). As the connecting electrode 173, for example, silver-palladium containing glass frit can be used.

The dummy connecting electrode 174 is located on the piezoelectric ceramic layer 22A so as not to overlap with various electrodes such as the individual electrode 172. The dummy connecting electrode 174 connects the piezoelectric actuator 22 and the flexible substrate 31 to enhance the connection strength.

The dummy connecting electrode 174 equalizes the distribution of the contact positions between the piezoelectric actuator 22 and the piezoelectric actuator 22, thereby stabilizing the electrical connection. The dummy connecting electrode 174 is preferably formed of a material and by a process equivalent to that of the connecting electrode 173.

The surface electrode 175 is formed on the piezoelectric ceramic layer 22A at a position to avoid the individual electrode 172. The surface electrode 175 is connected to the common electrode 171 through a via hole formed in the piezoelectric ceramic layer 22A. Thus, the surface electrode 175 is grounded and held at the ground potential. The surface electrode 175 may be preferably formed of the same material and process as the individual electrode 172.

A plurality of individual electrodes 172 are electrically connected individually to the controller 14 (see FIG. 1) each via the flexible substrate 31 and the wiring, so that the potential thereof is individually controlled. When the individual electrode 172 and the common electrode 171 are set to different potentials and an electric field is applied in the polarization direction of the piezoelectric ceramic layer 22A, the portion in the piezoelectric ceramic layer 22A to which the electric field is applied acts as an active portion distorted by the piezoelectric effect.

That is, in the piezoelectric actuator 22, the portion that faces the pressurizing chamber 162, in the individual electrode 172, the piezoelectric ceramic layer 22A, and the common electrode 171, functions as the displacement element 170. When the displacement element 170 is unimorphically deformed, the pressurizing chamber 162 is pressed, and the liquid is discharged from the discharge hole 163.

Next, the driving procedure of the liquid droplet discharge head 8 according to the embodiment will be described. First, the individual electrode 172 is set to have a higher potential (hereinafter referred to as “high potential”) than the common electrode 171 in advance. Each time the discharge request is made, the individual electrode 172 is set to the same potential (hereinafter referred to as a low potential) as the common electrode 171, and then set to the high potential again at a predetermined timing.

Thus, at the timing when the individual electrode 172 shifts to the low potential, the piezoelectric ceramic layers 22A, 22B return to their original shape, and the volume of the pressurizing chamber 162 increases over that in the initial state (a state where the potential differs between the two electrodes).

At this time, a negative pressure is applied to the pressurizing chamber 162, and the liquid is sucked into the pressurizing chamber 162 from the supply manifold 161 side. Then, at the timing when the individual electrode 172 is set to the high potential again, the piezoelectric ceramic layers 22A and 22B are deformed so as to convex toward the pressurizing chamber 162 side, and the pressure in the pressurizing chamber 162 becomes positive due to the decrease in the volume of the pressurizing chamber 162.

As a result, the pressure applied to the liquid inside the pressurizing chamber 162 increases, and droplets are discharged. In other words, in order to discharge the droplets, a driving signal including a pulse based on the high potential is supplied to the individual electrode 172.

The pulse width may be AL (Acoustic Length), which is the length of time for the pressure wave to propagate from the throttle 166 to the discharge hole 163. With this configuration, when the inside of the pressurizing chamber 162 transitions from the negative pressure state to the positive pressure state, the pressures under the states are combined, and thereby the liquid droplets can be discharged with higher pressure.

In the gradation printing, the gradation expression is performed by the number of droplets continuously discharged from the discharge hole 163, that is, the amount of droplets (volume) adjusted by the number of times of droplet discharge. Thus, the number of times of droplet discharge corresponding to the designated gradation expression is continuously performed from the discharge holes 163 corresponding to the designated dot region.

In general, when liquid discharge is performed continuously, the interval between the pulses supplied to discharge droplets may be AL. Thus, the period between the residual pressure wave of the pressure generated when discharging the droplets discharged earlier and the pressure wave of the pressure generated when discharging the droplets discharged later coincide. This can amplify the pressure for discharging the droplets due to overlapping of the residual pressure wave and the pressure wave. In this case, the velocity of the droplets discharged later increases, and the impact points of the plurality of droplets become close.

### Configuration of Base Film and Water-Repellent Film

The configuration of the base film 21J and the water-repellent film 21M according to the embodiment will be described with reference to FIGS. 7 and 8. FIG. 7 is a cross-sectional view along the VII-VII line illustrated in FIG. 5. FIG. 8 is a plan view of the base film 21J illustrated in FIG. 7.

As illustrated in FIG. 7, the head body 20 has the base film 21J and the water-repellent film 21M. The base film 21J is located on the surface of the nozzle plate 211, that is, on the first surface 21a of the channel member 21 (see FIG. 6). The water-repellent film 21M is located on the base film 21J.

The base film 21J and the water-repellent film 21M are formed on the first surface 21a by, for example, the following method. First, a base film 21J having a predetermined thickness is formed on the surface of the nozzle plate 21I. Then, a water-repellent film 21M is formed on the base film 21J. Thereafter, a heating treatment or a drying treatment is performed as necessary. The method of manufacturing the base film 21J and the water-repellent film 21M is not limited to the above-described method, and any method may be used.

As described above, in the liquid droplet discharge head 8 according to the embodiment, the base film 21J is located between the first surface 21a of the channel member 21 and the water-repellent film 21M, and thus, the adhesion between the channel member 21 and the water-repellent film 21M can be improved, compared to a case where the water-repellent film 21M is directly located on the first surface 21a. The materials of the base film 21J and the water-repellent film 21M will be described later.

However, when the base film 21J is formed inside an edge 100 of the discharge hole 163 in the method of manufacturing the base film 21J and the water-repellent film 21M, the water-repellent film 21M on the base film 21J is also formed inside the edge 100 of the discharge hole 163, and as a result, the tip of the discharge hole 163 has water repellency, and the discharge may become unstable. Here, the edge 100 of the discharge hole 163 is the boundary between the inner wall surface of the discharge hole 163 of the nozzle plate 21I and the first surface 21a of the channel member 21.

In the liquid droplet discharge head 8 according to the embodiment, as illustrated in FIG. 7, the film thickness of the base film 21J located in an edge region 80 of the discharge hole 163 decreases toward the edge 100 of the discharge hole 163. To be specific, the base film 21J located in the edge region 80 of the discharge hole 163 is inclined such that the film thickness of the base film 21J decreases toward the edge 100 of the discharge hole 163. In other words, the upper surface of the base film 21J located in the edge region 80 of the discharge hole 163 is inclined with respect to the upper surface of the nozzle plate 21I. Here, the edge region 80 of the discharge hole 163 is a concentric region in plan view including the edge 100 of the discharge hole 163, and is a concept including a region on the nozzle plate 21I. The edge region 80 of the discharge hole 163 is, for example, a range of 100 nm from the edge 100 of the discharge hole 163. For example, the base film 21J located in the edge region 80 of the discharge hole 163 is inclined at an angle of more than 20° and 40° or less with respect to the discharge direction (Z-axis direction). This reduces the possibility that the water-repellent film 21M on the base film 21J is formed inside the edge 100 of the discharge hole 163, and improves the discharge stability.

The base film 21J having such a shape can be formed by, for example, the following manufacturing method. To be specific, in the above-described process of manufacturing the base film 21J and the water-repellent film 21M, the water-repellent film 21M is formed on the base film 21J to have a predetermined thickness, and then the nozzle film is attached onto the water-repellent film 21M. For example, polyethylene terephthalate can be used as the material of the nozzle film. Thereafter, when the heating treatment and the pressurizing treatment are performed, the nozzle film enters the discharge hole 163 from the entrance thereof in the positive Z-axis direction by about 300 mn. Thereafter, the nozzle film is removed, and thus the base film 21J located in the edge region of the discharge hole 163 is shaved, and the inclined base film 21J is formed in the edge region 80 of the discharge hole 163 as described above. The inclination of the base film 21J of is formed within 500 nm from the edge 100 of the discharge hole 163.

Here, an example of a wiping process for the channel member 21 will be described with reference to FIG. 7.

As illustrated in FIG. 7, the wiping process is a process of wiping the surface of the water-repellent films 21M by moving a wiper 90 in a direction D1 along the first surface 21a, thereby removing the liquid adhering to the surface. The wiper 90 is, for example, an elastic member harder than the water-repellent film 21M. Specifically, a rubber member having a hardness of 30 to 90 can be applied as the wiper 90.

As described above, the base film 21J located in the edge region 80 of the discharge hole 163 is inclined, and thus the wiper 90 is less likely to interfere with the edge of the base film 21J. When the wiper 90 is caught on the edge of the base film 21J in the wiping process, the base film 21J and the water-repellent film 21M may be peeled off from the channel member 21. In contrast, in the embodiment, the wiper 90 is less likely to interfere with the edge of the base film 21J, and thus, the peeling of the base film 21J and the water-repellent film 21M can be reduced.

Returning to FIGS. 7 and 8, the configuration of the base film 21J and the water-repellent film 21M according to the embodiment will be further described.

The edge region 80 of the discharge hole 163 may be inclined downward toward the edge 100 of the discharge hole 163. To be specific, the edge region 80 may include a first inclined region R1 and a second inclined region R2. The first inclined region R1 includes the edge 100 of the discharge hole 163, and the second inclined region R2 is a region adjacent to the first inclined region R1. The first inclined region R1 is inclined at a first angle θ1 with respect to the first surface 21a of the channel member 21, and the second inclined region R2 is inclined at a second angle θ2 different from the first angle θ1 with respect to the first surface 21a of the channel member 21. The first inclined region R1 is narrower than the second inclined region R2 in the radial direction of the discharge hole 163.

As illustrated in FIG. 7, the first angle θ1 may be larger than the second angle θ2. Specifically, the difference between the first angle θ1 and the second angle θ2 may be more than 0° and 50° or less.

The water-repellent film 21M is located outside the discharge hole 163 in a perspective plan view. In other words, the water-repellent film 21M is not located inside the discharge hole 163 in a perspective plan view. The water-repellent film 21M does not overlap the discharge hole 163 in a perspective plan view. Since the water-repellent film 21M is not present inside the edge 100 of the discharge hole 163, the meniscus position of the ink is stabilized, and the landing accuracy in discharge is improved. The water-repellent film 21M is formed using, for example, a fluorine-containing silicon-based film formation material.

The base film 21J may include a metal film 21K and a metal oxide film 21L. The metal film 21K is, for example, a tantalum (Ta) film. The metal film 21K may be formed of titanium, chromium, aluminum, or silicon. The metal oxide film 21L is, for example, a tantalum oxide (TaOₓ, ₓ is 1 to 4) film. The metal film 21K may be formed of titanium oxide, chromium oxide, aluminum oxide, or silicon oxide.

According to this configuration, the fluoride atoms constituting the water-repellent film 21M and the oxygen atoms, the nitride atoms, or the carbon atoms constituting the base film 21J are easily bonded to each other, and the adhesion between the water-repellent film 21M and the base film 21J can be improved. According to the configuration, metal atoms constituting the nozzle plate 21I and oxygen atoms constituting the base film 21J are easily bonded to each other, and the adhesion between the base film 21J and the nozzle plate 21I can be improved. Therefore, the adhesion of the water-repellent film 21M, the base film 21J, and the nozzle plate 21I can be improved, and the peeling of the water-repellent film 21M and the base film 21J from the nozzle plate 21I can be reduced.

As illustrated in FIG. 7, a film thickness t1 of the metal film 21K may be greater than a film thickness t2 of the metal oxide film 21L. As illustrated in FIG. 7, the metal film 21K may protrude toward the inside of the discharge hole 163. The metal film 21K is amorphous and has higher toughness than the metal oxide film 21L. Therefore, according to this configuration, the stresses from the wiper 90 in the wiping process can be received by the metal film 21K, and the peeling of the base film 21J can be further reduced. The film thickness t1 of the metal film 21K is the thickness of the metal film 21K in a direction perpendicular to the surface of the nozzle plate 21I. The film thickness t2 of the metal oxide film 21L is the thickness of the metal film 21K in a direction perpendicular to the surface of the metal film 21K. The film thickness t1 of the metal film 21K and the film thickness t2 of the metal oxide film 21L can be measured by taking a cross-sectional photograph as illustrated in FIG. 7.

The base film 21J located on the first inclined region R1 may be exposed from the water-repellent film 21M. Specifically, the metal film 21K and the metal oxide film 21L located on the first inclined region R1 may be exposed from the water-repellent film 21M.

In an embodiment, (1) a liquid droplet discharge head (e.g., the liquid droplet discharge head 8) includes a channel member (e.g., the channel member 21), a base film (e.g., the base film 21J), and a water-repellent film (e.g., the water-repellent film 21M). The channel member includes a plurality of discharge holes (e.g., the discharge holes 163) in a first surface (e.g., the first surface 21a). The base film is located on the first surface. The water-repellent film is located on the base film. The base film located in an edge region (e.g., the edge region 80) including an edge (e.g., the edge 100) of the discharge hole has a film thickness that decreases toward the edge.
(2) In the liquid droplet discharge head according to (1), the edge region may include a first inclined region (e.g., the first inclined region R1) that includes the edge and is inclined at a first angle (e.g., the first angle θ1), and a second inclined region (e.g., the second inclined region R2) that is adjacent to the first inclined region and is inclined at a second angle (e.g., the second angle θ2) different from the first angle.
(3) In the liquid droplet discharge head according to (2), the first angle may be larger than the second angle.
(4) In the liquid droplet discharge head according to (3), a difference between the first angle and the second angle may be more than 0° and 50° or less.
(5) In the liquid droplet discharge head according to any one of (1) to (4), the water-repellent film may be located outside the discharge hole in a perspective plan view.
(6) In the liquid droplet discharge head according to any one of (1) to (5), the base film may include a metal film (e.g., the metal film 21K) and a metal oxide film (e.g., the metal oxide film 21L).
(7) In the liquid droplet discharge head according to (6), the metal film may be a tantalum film, and the metal oxide film may be a tantalum oxide film.
(8) In the liquid droplet discharge head according to (7), the tantalum film may have a film thickness greater than a film thickness of the tantalum oxide film.
(9) A recording device (e.g., the printer 1) may include the liquid droplet discharge head according to any one of (1) to (8), and a controller (e.g., the controller 14) that controls the liquid droplet discharge head.

Note that the embodiments disclosed herein are considered exemplary in all respects and not restrictive. Indeed, the embodiments described above may be embodied in various forms. The embodiments described above may also be omitted, replaced, or modified in various forms without departing from the scope and spirit of the attached claims.

1. A liquid droplet discharge head, comprising:
a channel member comprising a plurality of discharge holes in a first surface;
a base film located on the first surface; and
a water-repellent film located on the base film, wherein
the base film located in an edge region comprising an edge of the discharge hole has a film thickness that decreases toward the edge.

2. The liquid droplet discharge head according to claim 1, wherein the edge region comprises a first inclined region that comprises the edge and is inclined at a first angle, and a second inclined region that is adjacent to the first inclined region and is inclined at a second angle different from the first angle.

3. The liquid droplet discharge head according to claim 2, wherein the first angle is larger than the second angle.

4. The liquid droplet discharge head according to claim 3, wherein a difference between the first angle and the second angle is more than 0° and 50° or less.

5. The liquid droplet discharge head according to claim 1, wherein the water-repellent film is located outside the discharge hole in a perspective plan view.

6. The liquid droplet discharge head according to claim 1, wherein the base film comprises a metal film and a metal oxide film.

7. The liquid droplet discharge head according to claim 6, wherein:
the metal film is a tantalum film; and
the metal oxide film is a tantalum oxide film.

8. The liquid droplet discharge head according to claim 7, wherein the tantalum film has a film thickness greater than a film thickness of the tantalum oxide film.

9. A recording device comprising:
the liquid droplet discharge head according to claim 1; and
a controller configured to control the liquid droplet discharge head.
